(19) United States
(12) Patent Application Publication
(10) Pub. No.: US 2016/0165334 A1
(43) Pub. Date: Jun. 9, 2016

(54) HEARING DEVICE WITH SELF-CLEANING TUBING

(71) Applicant: Knowles Electronics, LLC, Itasca, IL (US)

(72) Inventor: Alex Grossman, Schaumburg, IL (US)

(21) Appl. No.: 14/949,101

(22) Filed: Nov. 23, 2015

Related U.S. Application Data
(60) Provisional application No. 62/086,941, filed on Dec. 3, 2014.

(51) Int. Cl. H04R 1/10; H04R 1/02

(52) U.S. Cl. CPC H04R 1/1066; H04R 1/023; H04R 1/1075; H04R 2201/003; H04R 2460/17

(57) ABSTRACT

An acoustic device that is configured to be disposed at least partially within an ear includes a hard inner sleeve, a soft or flexible outer sleeve, a speaker, a microphone, and a microphone chamber. The outer sleeve includes a first channel and a second channel. The first channel extends through the soft outer sleeve. A portion of the second channel is open and not surrounded by the hard inner sleeve on an outer surface of the hard outer sleeve. The soft outer sleeve at least partially surrounds the hard inner sleeve. The soft outer sleeve covers the portion of the second channel that is open to form an enclosed channel. The speaker is in communication with the first channel. The microphone chamber communicating with a microphone, and the microphone chamber is also in communication with the second channel via a port.

### CROSS-REFERENCE TO RELATED APPLICATION

This application claims the benefit of U.S. Provisional Patent Application Ser. No. 62/086,941, filed Dec. 3, 2014, entitled HEARING DEVICE WITH SELF-CLEANING TUBING which is incorporated by reference in its entirety herein.

### FIELD OF THE INVENTION

This application relates to hearing devices and, more specifically the structure and cleaning of these devices.

### BACKGROUND OF THE INVENTION

Different types of acoustic devices have been used through the years. One type of device is a microphone. In a microelectromechanical system (MEMS) microphone, a MEMS die includes a diagram and a back plate. The MEMS die is supported by a substrate and enclosed by a housing (e.g., a cup or cover with walls). A port may extend through the substrate (for a bottom port device) or through the top of the housing (for a top port device). In any case, sound energy traverses through the port, moves the diaphragm and creates a changing potential of the back plate, which creates an electrical signal.

Another type of acoustic device is a speaker. Speakers convert electric signals into sound energy. Various types of speakers exist such as dynamic speakers and armature-type speakers.

Speakers and receives are used together in some devices such as hearing devices. For example, in a hearing aid, a microphone picks up sound energy, converts it to electrical signals, which can be amplified and presented to a listener. Various types of headsets also exist that use both speakers and microphones.

With hearing devices, there are problems associated with wax build-up. More specifically, wax from a listener can clog portions of the hearing device or damage the internal microphones and speakers. With wax build up, the hearing instrument may not function properly. Other types of liquids and/or gases could also infiltrate the device and damage components.

Various solutions have been attempted, but these solutions have various drawbacks. These drawbacks have resulted in some user dissatisfaction with these previous approaches.

### BRIEF DESCRIPTION OF THE DRAWINGS

For a more complete understanding of the disclosure, reference should be made to the following detailed description and accompanying drawings wherein:

FIG. 1 comprises a perspective diagram of a hearing device according to various embodiments of the present invention;

FIG. 2 comprises a side cutaway view taken along line A-A of the hearing device of FIG. 1 according to various embodiments of the present invention;

FIG. 3 comprises a partial perspective diagram showing the various tubes associated with the microphone of FIGS. 1-2 according to various embodiments of the present invention;

FIG. 4 comprises a partial cross-sectional diagram looking from the bottom of the device of FIGS. 1-3 upward and showing tubing associated with the microphone according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

The present approaches provide a hearing device or instrument with a speaker and a microphone. The device has two separate channels leading from the ear canal. A first channel leads from the ear canal to a microphone, while a second channel leads from the ear canal to a speaker. A screen is placed within each of the passageways between the ear canal and the devices. The screens prevent contaminants from reaching the speaker and microphone. The passageway from the ear canal to the microphone is arranged to allow for easy cleaning and removal of contaminants.

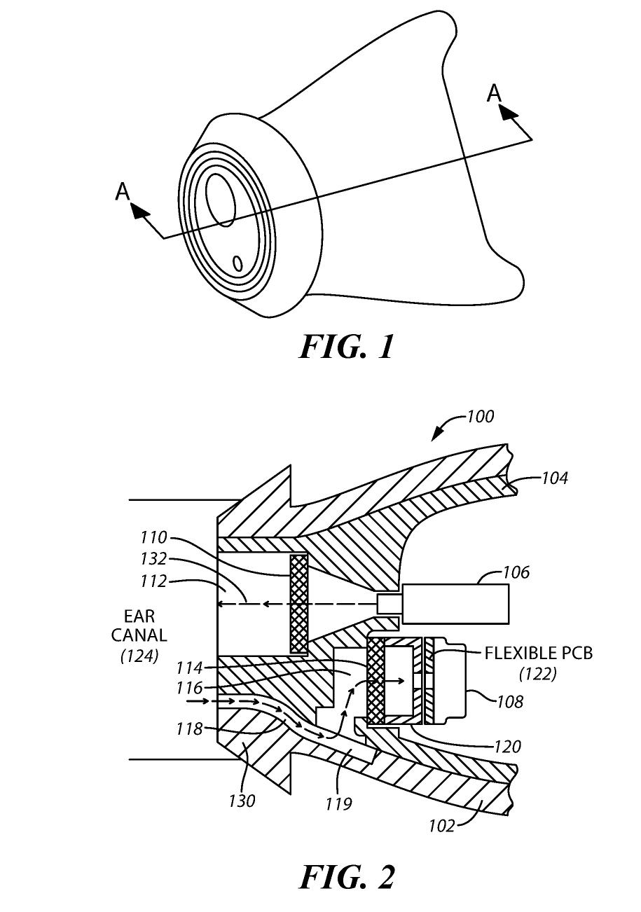

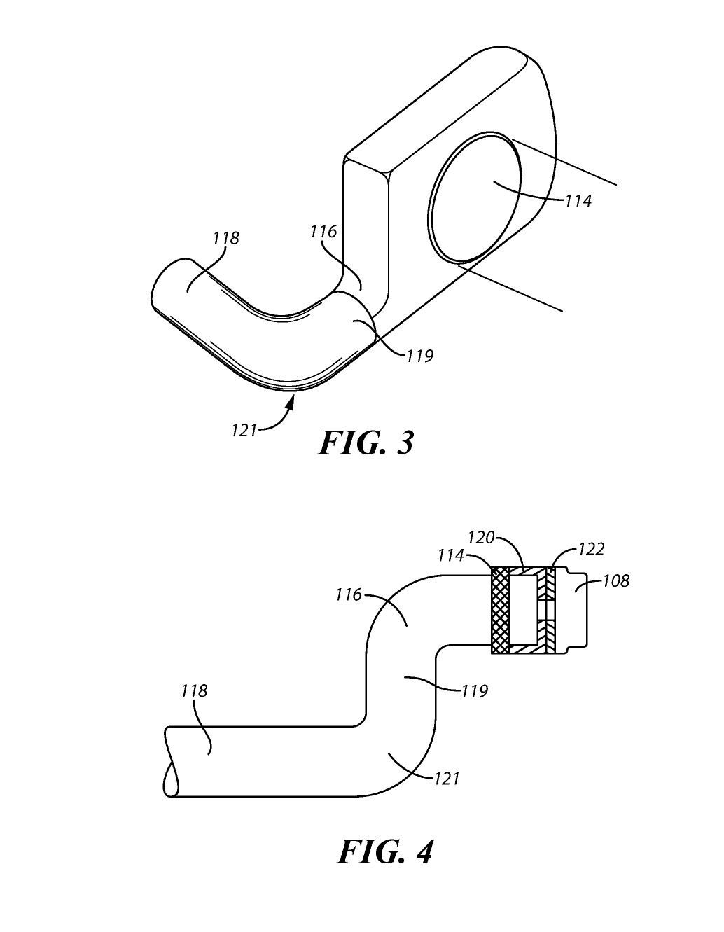

Referring now to FIG. 1, FIG. 2, FIG. 3, and FIG. 4, one example of a hearing device 100 is described. The hearing device 100 includes a soft outer sleeve 102, a hard inner shell 104, a receiver 106, a microphone 108, a first screen 110 (displaced in a first tube or channel 112), a second screen 114 (disposed in a chamber 116, the chamber 116 communicating with a second channel 118 via microphone reverse port 119), a port adapter 120, and a flexible printed circuit board (PCB) 122. The device 100 is disposed in the ear canal 124 of a listener.

The soft outer sleeve 102 may be constructed of a flexible material such as rubber or any elastomer. The hard inner shell 104 may be constructed of a hard plastic. Other examples of materials are possible.

The receiver 106 may be any type of speaker, but in one example, is a balanced armature speaker. The balanced armature speaker may include a coil, magnets, and yoke. Electrical current in the coil creates a changing magnetic flex, which moves an armature. The moving armature causes a drive rod to move, which moves a diaphragm. Movement of the diaphragm creates sound which is transmitted to the ear canal 124 of the listener via the tube or channel 112.

The microphone 108 may be a microelectromechanical system (MEMS) microphone having a diaphragm and back plate. Sound energy (entering the microphone 108 via tube 118, through port 119, through chamber 116 and screen 114) causes the diaphragm to move thereby creating a varying electrical potential with the back plate to create an electrical current. This current may be supplied to an application specific integrated circuit (ASIC) for further processing (e.g., amplification or noise removal). The output of the microphone 108 may be coupled to the receiver 106.

The first screen 110 is disposed in the first tube or channel 112, while the second screen 114 is disposed in a chamber 116. The screens 110 and 114 may be membranes, and in one example may be constructed of ePTFE. Other examples of screens are possible. One function of the screens 110 and 114 is to keep contaminants (solids, liquids, and/or gases) from reaching either the receiver 106 or the microphone 108. One specific example of a contaminant is ear wax.

The first channel 112 and the second channel 118 are separate from each other. Although shown as being circular in the cross section, it will be appreciated that the channel 112 and 118 may have any cross-sectional shape. In one illustrative example, the channels 112 and 118 have circular cross sections of approximately 3 mm in diameter. Other examples of dimensions and shapes are possible. In one aspect, channels 112 and 118 and screens 110 and 114 are separate from each other because a shared tube and or screen would reflect significant energy from the speaker into the microphone, making it difficult for the microphone to sense other signals present in the ear canal. Keeping the pathways separate avoids these problems.

The function of the port adapter 120 is to connect the microphone port having a small cross-sectional area with the much larger cross-sectional area of the screen 114.

The function of the flexible PCB 122 is to electrically connect the microphone 108 with the hearing instrument.

The soft outer sleeve 102 includes or has disposed within it the hollow channels 112 and 118. The sleeve 102 can be may be removed from the hard inner shell 104 and the channels 112 and 118 cleaned. In these regards, nearly the entire length (or a substantial length) of the channel 118 is created at the interface between the hard inner shell 104 and the soft outer sleeve 102. Pulling off the soft outer sleeve 102 away from the hard inner shell 104 then exposes the channel 118, making it easy to wipe out any trapped debris such as ear wax.

In addition and as described further below, the placement of the port 119 and chamber 116 allows built up wax within channel 118, port 119, or chamber 116 to be removed (e.g., fall out or be torn out) as the sleeve 102 is removed from the shell 104.

In one aspect, the vertical placement of the screens 110 and 114 is staggered in the device. That is, as viewed in the cross section of FIG. 2, the screens 110 and 114 are not disposed vertically one-on-top of another. Instead, the screens 110 and 114 are not vertically one-on-top of another, but horizontally displaced from each other. This placement allows the area of each of the screens to remain large (and in one example be the same), which helps to maintain the acoustic properties of the device 100. In other words, if the area of the screens were too small, the acoustic properties of the device 100 would be adversely impacted.

The bottom channel makes an L-like twist 121 as it communicates with the port 119, which opens into the chamber 116. As shown in FIG. 3, the empty spaces of the chamber 116 are shown as a rectangular box and the hollow tube or channel 118 is illustrated as a three-dimensional tube. The placement of the port 119 and chamber 116 together with the L-like twist 121 allows built up wax within channel 118, port 119, or chamber 116 to be easily removed (e.g., fall out or be torn out) as the sleeve 102 is removed from the shell 104. After removal, the tubes 112 and 118 can be easily cleaned.

In one example of the acoustic operation of the device 100, sound is created in the ear canal 124 of the user (e.g., for example, by the user talking), and traverses along the path labeled 130 to the microphone 108. The microphone 108 causes this to be converted into an electrical signal. The electrical signal can be transmitted to the receiver 106.

The receiver 106 receives various signals from various sources (e.g., a signal from the microphone 108 after the signal has been processed, devices external to the device 100 (e.g., music sources), other external microphones picking up sounds external to the device 100), and converts these electrical signals into sound energy. The sound energy may traverse the path labeled 132 to the ear canal 124 of the listener via the channel 128.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An acoustic device that is configured to be disposed at least partially within an ear, the acoustic device comprising:
a hard inner sleeve including a first channel and a second channel, wherein the first channel extends through the soft outer sleeve, and wherein a portion of the second channel is open and not surrounded by the hard inner sleeve on an outer surface of the hard outer sleeve;
a soft outer sleeve, wherein the soft outer sleeve at least partially surrounds the hard inner sleeve, and wherein the soft outer sleeve covers the portion of the second channel that is open to form an enclosed channel;
a speaker in communication with the first channel;
a microphone; and
a microphone chamber communicating with the microphone, wherein the microphone chamber is also in communication with the second channel via a port.

2. The acoustic device of claim 1, wherein the soft outer sleeve is removable from the hard inner sleeve.

3. The acoustic device of claim 2, wherein an inner surface of the second channel is exposed when the soft inner sleeve is removed.

4. The acoustic device of claim 1, wherein the hard inner sleeve comprises plastic.

5. The acoustic device of claim 1, wherein the soft outer sleeve comprises an elastomer.

6. The acoustic device of claim 1, wherein the second channel extends from the port toward an ear canal of the ear.

7. The acoustic device of claim 1, further comprising:
a first screen disposed within the first channel; and
a second screen disposed within the microphone chamber.

8. The acoustic device of claim 7, wherein the first screen and the second screen are horizontally displaced with respect to one another.

9. The acoustic device of claim 7, wherein the first screen and the second screen comprise expanded polytetrafluoroethylene.

10. The acoustic device of claim 1, wherein the second channel includes an L-shaped twist before the port.
